(19) United States
(12) Patent Application Publication
(10) Pub. No.: US 2006/0227937 A1
(43) Pub. Date: Oct. 12, 2006

(54) Cover for image detector

(75) Inventor: Christopher D. Unger, Brookfield, WI (US)

Correspondence Address: MCANDREWS HELD & MALLOY, LTD, 500 WEST MADISON STREET, SUITE 3400, CHICAGO, IL, 60661, US

(73) Assignee: General Electric Company, Schenectady, NY (US)

(21) Appl. No.: 11/104,084

(22) Filed: Apr. 12, 2005

(51) Int. Cl. H01J 31/50; H01J 31/49

(52) U.S. Cl. 378/189

(57) ABSTRACT

A cover for use with an image detector. The cover defines an interior region that receives a portable image detector such that the image detector captures an image when located in the interior region.

### BACKGROUND OF THE INVENTION

The present invention relates to a cover used with imaging equipment in medical facilities. More particularly, certain embodiments of the present invention relate to a cover that receives, and protects, an X-ray image detector used with a portable X-ray machine.

Before and during a medical procedure, medical technicians may need to use an imaging device to take several different images of a patient's body from a number of different orientations. Where the imaging device is fixed and stationary, it may be difficult to effectively position the imaging to device to capture images from certain orientations about the patient's body. Furthermore, stationary imaging devices cannot be moved to patients who may be too ill for transport to the imaging device. Therefore, technicians use portable imaging devices that can be moved for use with patients in different areas throughout a medical facility and that can be positioned to different orientations about a patient. In order to use a portable X-ray machine, the patient lays on a table or bed and an X-ray detector, such as a radiography plate or a direct digital detector, is positioned underneath a region of interest of the patient's body. The X-ray machine has an imaging source that is moved to a position in alignment with the X-ray detector to take an image of the region of interest. The portable X-ray source is then activated to record an image of the region of interest on the image detector for later review by the medical staff.

However, the portable imaging system has some drawbacks. As imaging technology improves, the image detectors include more advanced components and thus become larger and heavier A typical image detector can weigh between 10-14 pounds. The heavy weight of the image detector can make the imaging process very difficult, especially when the image detector must be used with heavier patients. For example, when the patient is positioned on the table, the technician must lift or move the patient with one hand while using the other hand to position the image detector under the patient in alignment with the imaging source. Because the technician is focusing on the patient, who may be very ill, it is easy for the technician to accidentally drop the heavy detector. Furthermore, the image detector can be damaged after repeatedly being placed under heavy patients. Because image detectors can cost well over $10,000, any damage to the image detector is an expensive problem for a cash-strapped medical facility.

Therefore, a need exists for a device that will facilitate positioning the image detector under heavier patients while reducing the possibility that the image detector will be damaged.

### BRIEF SUMMARY OF THE INVENTION

Certain embodiments of the present invention include a cover for use with an image detector. The cover defines an interior region and receives a portable image detector into the interior region such that the image detector captures an image when located in the interior region.

Certain embodiments of the invention include an imaging system. The imaging system includes an imaging source, an image detector, and a cover defining an interior region. The cover receives the image detector into the interior region, wherein the cover is positioned relative to an imaging source such that the imaging source produces an image on the image detector.

Certain embodiments of the invention include a method for taking an image. The method includes placing a cover proximate to a region of interest of a patient, inserting an image detector into the cover, positioning an imaging source relative to the region of interest and the image detector such that the region of interest is between the imaging source and the image detector, and creating an image of the region of interest on the image detector with the imaging source.

### BRIEF DESCRIPTION OF SEVERAL VIEWS OF THE DRAWINGS

FIG. 1 illustrates a side view of a portable imaging device formed according to an embodiment of the present invention.

FIG. 2 illustrates a top isometric view of an image detector formed according to an embodiment of the present invention.

FIG. 3 illustrates a front isometric view of a cover formed according to an embodiment of the present invention.

FIG. 4 illustrates a side isometric view of the cover of FIG. 3 and the image detector of FIG. 2 formed according to an embodiment of the present invention.

FIG. 5 illustrates a front isometric view of the image detector of FIG. 2 fully inserted into the cover of FIG. 3.

FIG. 6 illustrates a side view of the imaging source of FIG. 1 being used to take an image of a region of interest on a patient formed according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

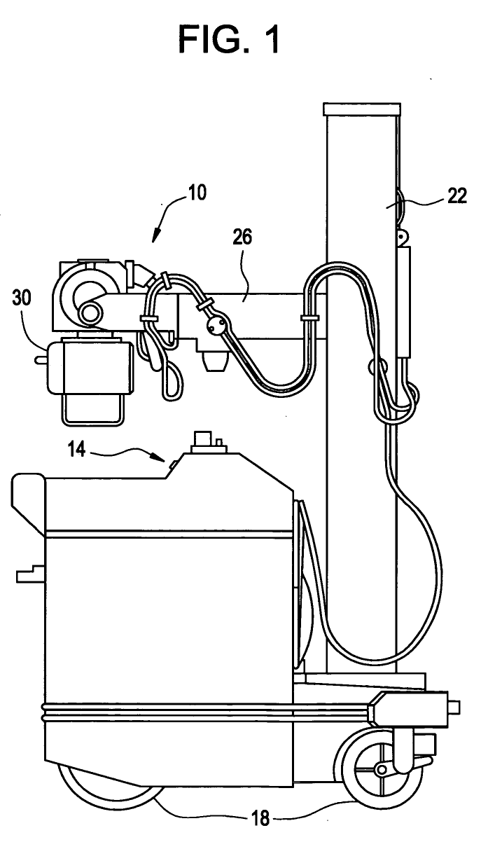

FIG. 1 illustrates a side isometric view of a portable imaging device 10. The portable imaging device 10 includes an operating station or computer system 14 mounted on wheels 18. A post 22 extends from the operating station 14 and has an arm 26 mounted thereto. An imaging source 30 is rotatably connected to the arm 26. By way of example only, the imaging source 30 is an X-ray source using an X-ray tube. Alternatively, the imaging source 30 may include other kinds of imaging technology. The imaging source 30 is connected to the operating station 14 such that a technician using the operating station 14 can operate the imaging source 30. The imaging source 30, the arm 26, and the post 22 are all connected to each other such that the imaging source 30 may be moved to different positions and orientations to be directed at a region of interest of the patient. The wheels 18 allows the portable imaging device 10 to be moved for use with patients located in different areas throughout a medical facility.

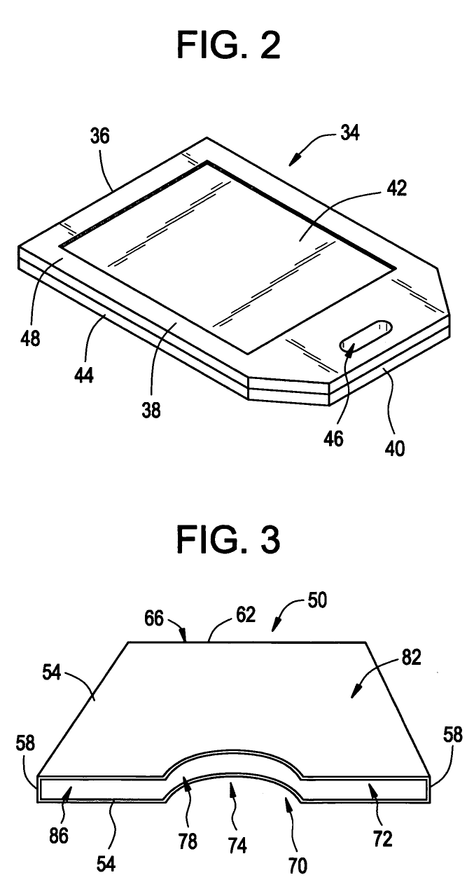

FIG. 2 illustrates a top isometric view of an image detector 34 for use with the imaging device 10 (FIG. 1) formed according to an embodiment of the present invention. The image detector 34 is planar in shape and has a hard casing 38 surrounding a plate 42. The image detector 34 has a back end 36, a front end 40, side ends 44, and sides 48. The casing 38 includes an aperture 46 proximate the front end 40 that enables a technician to hold the image detector 34 by hand. The casing 38 may be made of metal, such as magnesium, or any other strong material. The plate 42 may be made out of glass or any other material that enables receiving an image during use with the imaging device 10. Beneath the surface of the plate 42, the image detector 34 includes components for receiving images created by the imaging source 30 (FIG. 1). The image detector 34 may receive an X-ray from the imaging source 30, capture the image from the X-ray, and then transmit the image to a computer for the technician to view on a screen. By way of example only, the image detector 34 may include a computed radiography plate that digitally transmits the image to a computer. Alternatively, the image detector 34 is not limited to use with X-ray imaging technology but may be used with CT scan technology or other imaging technology. The image detector 34 may weigh up to at least 14 pounds.

FIG. 3 illustrates a front isometric view of a cover or sleeve 50 formed according to an embodiment of the present invention. The cover 50 has side walls 54 joined with end walls 58 to form an enclosure. The cover 50 has a back wall 62 closing off a back end 66 and has an open front end 70. Alternatively, the back end 66 may be open as well as the front end 70. At least one side wall 54 has a curved gap 74 proximate the front end 70. The front end 70 defines an opening or mouth 72 that allows passage into a hollow interior region 78 of the cover 50 that receives the image detector 34 (FIG. 2). The cover 50 may be made of plastic, structural composites, resin, fiberglass or any number of other strong rigid, lightweight materials. By way of example only, the cover 50 may weigh less than 3.33 pounds (approximately 1.5 kilograms). The cover 50 has an exterior surface 82 that may be configured such that the cover 50 is easy to grip and does not slide along smooth surfaces. For example, the exterior surface 82 may have ridges, gaps, or dimples or the exterior surface 82 may be made of a high-friction, or slip-proof or slide-resistant material such as rubber. Alternatively, at least the exterior surface of the cover 50 may be made of a low-friction material to enable sliding the cover 50 along a surface and under a patient's region of interest. The cover 50 has an interior surface 86 that that may be smooth, and made of a low-friction material, such that the image detector 34 easily slides into the interior 78 of the cover 50. Also, the cover 50 may be configured such that that image detector 34 can be secured within the cover 50. By way of example only, the cover 50 may have clasps, or straps, or surfaces that retain the image detector 34 within the cover 50. Alternatively, the front end 70 may include a door that closes about the mouth 72 to secure the image detector 34 in the cover 50. The cover 50 may be made of, or have portions made of, a radio-transparent or radio-translucent material to minimize attenuation of X-rays passing therethrough. Such materials may include, but are not limited to, carbon fiber composites, Kevlar composites, or Sectra composites, or fiberglass.

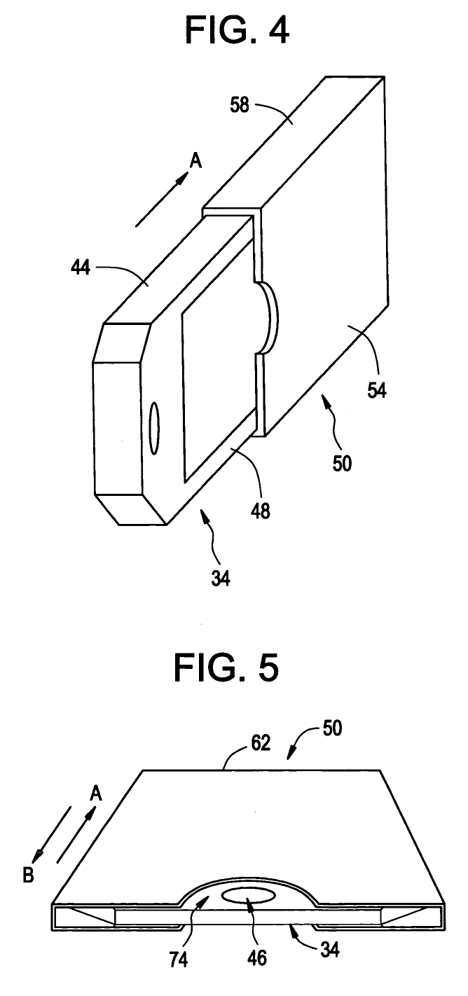

FIG. 4 illustrates the cover 50 receiving the image detector 34. The image detector 34 is inserted into the interior 78 (FIG. 2) of the cover 50 by placing the back end 36 (FIG. 2) of the image detector 34 into the cover 50 in the direction of arrow A with the side ends 44 and sides 48 of the image detector 34 sliding along the end walls 58 and side walls 54, respectively, of the cover 50.

FIG. 5 illustrates a front isometric view of the image detector 34 fully inserted into the cover 50. The image detector 34 is slid all the way into the cover 50 in the direction of arrow A until the back end 36 (FIG. 2) of the image detector 34 engages the back wall 62 of the cover 50. When the image detector 34 is fully inserted into the cover 50, the aperture 46 of the image detector 34 is exposed by the gaps 74 of the cover 50. In order to remove the image detector 34 from the cover 50, a technician simply uses the aperture 46 to pull the image detector 34 in the direction of arrow B out of the cover 50.

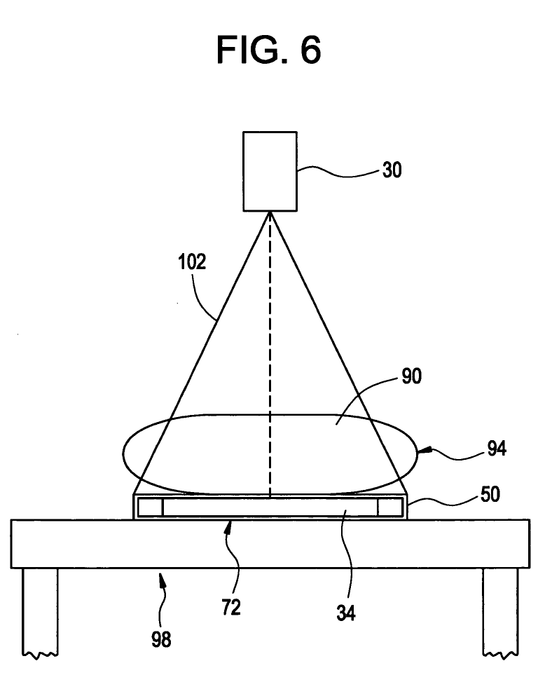

FIG. 6 illustrates a side view of the imaging source 30 being used to take an image of a region of interest 90 on a patient 94. In operation, the technician positions the cover 50 on a surface such as a bed or table 98. The technician then positions the patient 94 on the table 98 with the region of interest 90 positioned on top of, or proximate to, the cover 50. Alternatively, the technician may place the cover 50 proximate to the region of interest 90 already positioned on the table 98. By way of example only, the region of interest 90 may be the abdomen of the patient 94. The technician then takes the image detector 34 and moves the region of interest 90 to slide the image detector 34 into the mouth 72 (FIG. 3) of the cover 50 and into the interior 78 (FIG. 3) of the cover 50 as shown in FIGS. 4 and 5. The technician moves the region of interest 90 back onto the cover 50. The technician then moves the imaging source 30 about the region of interest 90 such that the imaging source 30 is aligned with the image detector 34. The technician then operates the imaging source 30 at the operating station 14 (FIG. 1) such that the imaging source 30 produces images that are received by the image detector 34. By way of example only, the imaging source 30 produces X-rays 102 that leave X-ray images on the image detector 34. The image detector 34 may then transmit the images to the operating station 14 or any other station where the technician can view the images. When the technician is finished making images, the technician lifts the patient off of the cover 50 and then removes the image detector 34 from the cover 50. Alternatively, after the technician is finished taking images, the technician removes the image detector 34 from the cover 50 and then removes the cover 50 from underneath the patient. Alternatively, if the image detector 34 is not configured to transmit images but stores the images on a cassette or plate, the images can then be recovered from the image detector 34.

Returning to FIG. 3, the cover 50 may be made of materials strong enough such that when the cover 50 is positioned by itself under the patient, the side walls 54 do not bend into the interior 78 of the cover 50 under the weight of the patient. In this way, the image detector 34 (FIG. 2) does not bear the weight of the patient when positioned within the cover 50 under the patient. Alternatively, the cover 50 may be made of such materials that the image detector 34 does bear some weight when positioned within the cover 50.

Alternatively, the cover 50 can be a box with an open end that can be closed after receiving the image detector 34. Alternatively, the cover 50 may have only one side wall 54 and have an open side opposite the side wall 54 such that the cover 50 resembles a tray that may be placed on the table 98 with the side wall 54 facing up to engage the patient and the table 98 serving as the other side wall 54. Alternatively, the cover 50 may not have end walls 58 but may have two side walls 54 formed with each other to define an envelope or sleeve that receives the image detector 34.

The cover of the different embodiments provides a number of benefits. The cover serves as a placeholder for the image detector such that, after the technician places the cover in position on the table, the technician may concentrate on moving the patient into position without having to also position the image detector under the patient. Once the technician has the patient properly positioned on top of the cover, the technician then only has to move the patient enough to expose the front end of the cover and slide the image detector into the cover. Also, because the cover is lightweight, the technician can easily manipulate the cover with one hand while moving the patient with the other hand to get the cover in proper position. The cover also serves to protect the image detector from being damaged from contact with the patient and being subjected to the full weight of the patient. Because the cover is cheap to make and replace, the cover helps prolong the life of the image detector with minimal costs. Furthermore, multiple covers can be used with multiple patients such that each patient can be set up on their own cover and the technician can then move from patient to patient with a single image detector to take images and thus save much time and effort from having to realign the image detector with each patient.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A cover for use with an image detector, comprising:
a cover defining an interior region, said cover receiving a portable image detector into said interior region such that said image detector captures an image when located in said interior region.

2. The cover of claim 1, wherein said cover is positioned relative to an imaging source such that said imaging source produces the image on said image detector.

3. The cover of claim 1, wherein said cover is positioned relative to a region of interest and an imaging source such that said imaging source produces an image of said region of interest on said image detector.

4. The cover of claim 1, wherein said cover has at least one opening, said image detector being insertable into said interior region through said at least one opening and being removable from said interior region through said at least one opening.

5. The cover of claim 1, wherein said cover has at least one gap that exposes a portion of said image detector.

6. The cover of claim 1, wherein said cover is made of a high-friction material to limit the cover from sliding along other surfaces.

7. The cover of claim 1, wherein said cover is made of a low-friction material to enable placing said image detector under said region of interest.

8. The cover of claim 1, wherein said cover is made of at least one of plastic, resin, composite, fiberglass, or any other rigid, lightweight material.

9. The cover of claim 1, wherein said cover weighs no more than 1.5 kilograms.

10. The cover of claim 1, wherein said cover is at least partially made of radio-transparent or radio-translucent material.

11. An imaging system, comprising:
an imaging source;
an image detector; and
a cover defining an interior region, said cover receiving said image detector into said interior region, wherein said cover is positioned relative to said imaging source such that said imaging source produces an image on said image detector.

12. The imaging system of claim 11, wherein said image detector transmits said image to a computer system.

13. The cover of claim 11, wherein said cover is positioned relative to a region of interest and said imaging source such that said imaging source produces an image of said region of interest on said image detector.

14. The cover of claim 11, wherein said cover includes at least one opening, said image detector being insertable into said interior region through said at least one opening and being removable from said interior region through said at least one opening.

15. The cover of claim 11, wherein said cover has at least one gap that exposes a portion of said image detector.

16. The cover of claim 11, wherein said cover is made of a high-friction material to limit the cover from sliding along other surfaces.

17. The cover of claim 11, wherein said cover is made of a low-friction material to enable placing said image detector under a region of interest.

18. The cover of claim 11, wherein said cover is made of at least one of plastic, resin, composite, or fiberglass, or any other rigid lightweight material.

19. The cover of claim 11, wherein said cover weighs no more than 1.5 kilograms.

20. A method for taking an image, comprising:
placing a cover proximate to a region of interest of a patient;
inserting an image detector into the cover;
positioning an imaging source relative to the region of interest and the image detector such that the region of interest is between the imaging source and the image detector; and
creating an image of the region of interest on the image detector with the imaging source.
